(19) United States
(12) Patent Application Publication
(10) Pub. No.: US 2004/0189083 A1
(43) Pub. Date: Sep. 30, 2004

(54) Hydraulic brake circuit

(76) Inventors: Stan Nowak, Balcatta (AU); Dorota Kieronska, Balcatta (AU); Vin C Morley, Balcatta (AU)

Correspondence Address: ROTHWELL, FIGG, ERNST & MANBECK, P.C., 1425 K STREET, N.W., SUITE 800, WASHINGTON, DC, 20005, US

(21) Appl. No.: 10/488,003

(22) PCT Filed: Aug. 30, 2002
(86) PCT No.: PCT/AU02/01193

(30) Foreign Application Priority Data
Aug. 31, 2001 (AU) PR 7394

(51) Int. Cl. B60T 7/00

(52) U.S. Cl. 303/15

(57) ABSTRACT

A hydraulic brake system (10) for operating service brakes (12, 14) and (16) is provided with first and second master cylinders (20, 22) which feed into input ports (26) and (28) of a valve (24). Duplicate hydraulic circuits (30 ) and (34) are coupled with respective output ports (32) and (36) of the valve (24). Each of the hydraulic circuits (30) and (34) also includes a common circuit portion comprising a selective valve (44) and common line (42) leading to brake (16). The system (10) also includes hand brake (18) which is electrically deployed and manually released. A controller (52) controls operation of the system (10) to switch between master cylinders (20) and (22 ), and hydraulic circuits (30) and (34), depending on sensed fluid pressure. In the event of switching both master cylinders (20) and (22) to one of the hydraulic circuits (30) or (34), and a controller continuing to sense low fluid pressure, the common circuit is isolated. In the event of a sensed complete hydraulic failure, the controller (52) automatically deploys the park brake (18).

### FIELD OF THE INVENTION

The present invention relates to a hydraulic brake circuit, in particular, though not exclusively, for use in machines and motor vehicles.

### BACKGROUND OF THE INVENTION

The present Applicant is the proprietor of numerous inventions relating to wet and dry braking systems for use in machines and motor vehicles, examples of which are described in International Application Nos. PCT/AU95/00529 and PCT/AU97/00500.

Many of the Applicant's innovations in relation to braking systems related to the “wheel end” of the system where a friction material is placed into contact with a rotating body to cause a braking effect. However an equally important aspect of a braking system is the delivery of operational power to the moving components of the system in order to bring the friction material into contact with the rotating body. Most commonly, this is achieved by way of a hydraulic circuit commencing with a brake pedal that operates a master cylinder which in turn is coupled by a conduit to a piston moving a brake pad or shoe into contact with a rotating body. A fault in the hydraulic circuit such as a drop in fluid pressure in the master cylinder or a break in the conduit naturally leads to reduced low performance or total brake failure. Such faults are often only detected when the brakes are applied, though in some instances, they may only become apparent during times of heavy braking.

### SUMMARY OF THE INVENTION

The present invention was developed with a view to providing a hydraulic brake circuit with improved safety characteristics.

According to the present invention there is provided a hydraulic brake system for a machine, said hydraulic brake system including:

at least one hydraulically actuated service brake;

at least one electrically deployable and manually releasable park brake;

first and second master cylinders;

a first valve having first and second input ports in fluid communication with said first and second master cylinders respectively;

a first hydraulic circuit in fluid communication with a first output port of said first valve, said first hydraulic circuit in fluid communication with said at least one service brake;

a second hydraulic circuit in fluid communication with a second output port of said first valve, said second hydraulic circuit in fluid communication with said at least one service brake;

a controller provided with one or more sensors for sensing operational characteristics of said hydraulic brake system including fluid pressure in said first and second hydraulic circuits, said controller operable for switching said first valve for selectively fluidly coupling said first or second master cylinders to said first or second hydraulic circuits and further operable for deploying said park brake upon detection of one or more triggering events.

Preferably, when said machine is a vehicle having an ignition system switchable between an ON state and an OFF state, a first one of said triggering events is detection of an OFF state of said ignition system.

Preferably said at least one hydraulically actuated service brake includes a first hydraulically actuated service brake and a second hydraulically actuated service brake, and each of first and second hydraulic circuits includes a second common valve having first and second input ports in fluid communication with said first and second output ports of said first valve respectively, and an output port in fluid communication through a common line to said second of said service brakes.

Preferably said controller conducts a first routine to ascertain whether fluid pressure in a selected one of said first and second hydraulic circuits is below pre-determined determined level and, if so, operates said first valve to change the master cylinder fluidly coupled to said selected hydraulic circuit.

Preferably subsequent to first routine, said controller conducts a second routine to ascertain whether, said change in the master cylinder fluidly coupled to the selected hydraulic circuit, is the first change since a most recent switching of said ignition system to said ON state and if so said controller loops back to said first routine, and if not, said controller operates said second valve to fluidly isolate said second service brake from said first and second hydraulic circuits.

Preferably subsequent to said second routine, said controller initiates a timer to ascertain whether a brake pedal operatively associated with said first and second master cylinders has been depressed within a time interval, and if not, classifies the failure to depress said brake circuit as a second one of said triggering events and consequently deploys said park brake.

Preferably if said controller determines that said brake pedal has been depressed within said time interval but subsequently ascertains that depression of said brake pedal does not result in fluid pressure in said selected hydraulic circuit exceeding a pre-determined level, said controller classifies the failure of the fluid pressure to exceed the pre-determined level as a third of said triggering events and consequently deploys said park brake.

Preferably, said controller, upon detecting said second or third triggering events, switches said ignition system to said OFF state.

### A BRIEF DESCRIPTION OF THE DRAWING

An embodiment of the present invention will now be described by way of example only with reference to the accompanying drawings in which:

FIG. 1 schematically depicts one embodiment of an hydraulic brake circuit in accordance with the present invention; and,

FIG. 2 is a flow chart illustrating one possible operating logic for a controller incorporated in the circuit.

### DETAILED DESCRIPTION OF PREFERRED EMBODIMENT

The present embodiment of the invention is being described in relation to use on a motor vehicle. However, it is to be understood that embodiments of the present invention can be incorporated into other machines for braking rotational motion of components thereof, for example, a winch of a crane or an elevator.

The accompanying drawing depicts an embodiment of an hydraulic brake system 10 for a vehicle having a plurality of wheels (not shown). The hydraulic brake system 10 includes hydraulically actuated service brakes and 12, 14 and 16; and at least one electrically deployable and manually releasable park brake 18.

The service brakes 12 and 14 are shown as separate brakes and, may indeed be separate physical brakes attached to different wheels of a vehicle. However alternately, they may represent the same physical brake but fed by different hydraulic circuits and therefore notionally can be considered as separate brakes. Similarly, the service brake 16 is depicted as a single physical brake but may take the form of separate physical brakes attached to different wheels.

The system 10 further includes first and second master cylinders 20 and 22 and a first electrically operated hydraulic valve 24 having first and second input ports 26 and 28 in fluid communication with the first and second master cylinders 20 and 22 respectively. The valve 24 is a four port two position solenoid actuated hydraulic valve which, in the depicted embodiment is simulated by actuating two three port two position valves 24a and 24b back to back simultaneously. A first hydraulic circuit 30 provides fluid communication between an output port 32 of the valve 24 and the service brakes 12 and 16. A second hydraulic circuit 34 provides fluid communication between a second output port 36 of the valve 24 and the service brakes 14 and 16. In this regard, the circuit 30 includes: conduit 38, common reverse selector valve 40, and common line 42 extending from an output port 44 of the valve 40 and the service brake 16. The conduit 38 is a branched conduit extending between the output 32 of the valve 24, input port 46 of the valve 40, and the service brake 12.

The second hydraulic circuit 34 includes: a conduit 48, together with the valve 40 and common line 42. The conduit 48 is a branched conduit extending between the output 36 of valve 24, the service brake 14, and a second input port 50 of the valve 40.

The system 10 further includes an electronic control circuit, or controller 52 which is provided with a plurality of sensors (described in greater detail below) for sensing operational characteristics of the system 10 including fluid pressure in the hydraulic circuits 30 and 34 and the master cylinders 20 and 22, and for switching the valve 24 and valve 40 for selectively coupling one of the master cylinders 20 or 22 to a selected one of the first and second hydraulic circuits 30 and 34 including the common line 42. The controller 52 further operates to deploy the park brake 18 upon detection of one or more triggering events. When the system 10 is used in a vehicle having an ignition system 72 which is switchable between an ON state and an OFF state one of the triggering events is detecting an OFF state of the ignition system. Thus, the system 10 automatically deploys the park brake 18 when vehicle ignition is OFF.

To assist in the operation of the system 10, boosters 54 and 56 are provided in fluid communication with the master cylinders 20 and 22 respectively and operated in common by depressing of brake pedal 58. A vacuum pump 60 is further provided and coupled in a conventional manner to assist in the braking operation.

The park brake 18 is applied electrically but can be released either manually if the ignition system is OFF, or electrically if the ignition system is ON. The park brake 18 incorporates a spring 62 for biasing brake pads or shoes (not shown) onto a rotating component of the brake system to provide a braking effect. Assuming the ignition system is ON, the spring 62 is held in a relatively compressed state where the park brake 18 is in the OFF state by a solenoid 64 which is connected to and operated by the controller 52. When the solenoid 64 is de-energised, either due to the ignition being turned OFF, or when the ignition is ON, by pressing a park brake APPLY button (not shown) the spring 62 biases brake shoes or pads onto a rotating component to provide the braking effect. In order to then release the park brake 18, one or more levers 66 must be pulled to retract the spring 62 back into the relatively compressed state or alternately if the ignition is ON press a park brake RELEASE button (not shown) which via the controller 52 energises the solenoid 64. Conventional mechanical links are provided between the lever 66 and the spring 62 to facilitate manual park brake release when the ignition is OFF. It would be appreciated that this form of manual park brake release is completely opposite to the conventional style of hand brake in which a lever is pulled in order to deploy the park brake.

An isolation valve 68 is placed in the common circuit 42 to the service brake 16 and is operatively associated with the valve 24 so that when the isolation valve 68 is operated, it effectively isolates a selected one of the hydraulic circuits 30 or 34 from the remainder of the system hydraulics and in particular master cylinders 20 and 22, and switches the other hydraulic circuit 30 or 34, but not the common conduit 42, into fluid communication with the designated master cylinder. The isolation valve 68 typically is operated when the fluid pressure in one of the hydraulic circuits 30 or 34 is sensed as being less than a predetermined minimum level. This is indicative of a fault, such as a rupture, in one of the circuits 30 or 34. Thus upon detection of the fault the controller 52 effectively switches out the hydraulic circuit 30 or 34 (inclusive of the common conduit 42 and service brake 16) in which the fault was detected and connects the other hydraulic circuit into fluid communication with the current designated master cylinder. This is done by the controller 52 operating the isolation valve 68 to shut off the conduit 42 and operating valve 24 to connect the designated primary cylinder 20 or 22 to the other hydraulic circuit 30 or 34. It will be recognised that when this occurs, the service brake 16 remains inoperable due to the isolation of common conduit 42.

As mentioned above, the controller 52 includes a plurality of sensors for sensing various operational characteristics of the system 10. These sensors includes an ignition state sensor 70 for sensing the state of ignition system 72; fluid pressure sensors 74, 76 for sensing fluid pressure in conduits 38, 48, vacuum pressure sensor 80 for sensing pressure at the vacuum pump reservoir 60; brake pedal position sensor 82 for sensing the position of the brake pedal 58.

Controller 52 may also be coupled to a plurality of visual and/or audio indicators located within a cabin of a vehicle fitted with the system 10 for providing visual and/or audible signals relating to the operational characteristics sensed by the sensors 70, 74, 76, 78, 80, 82, 84, 86 and 88.

With the system 10 fitted to a vehicle and the vehicle having an ignition system, when the ignition system is OFF, the brake system 10 automatically deploys the park brake 18 by de-energising the solenoid 64 allowing the spring 62 to bias brake shoes or pads onto one or more rotors fitted to one or more wheels of the vehicle. In order to electrically release the park brake 18, the ignition system 72 must be turned ON. The controller then energises the solenoid 64 to hold the spring 62 in the relatively compressed state. Alternately if the ignition is OFF the park brake 18 can be released manually by pulling on or otherwise manually manipulating lever 66.

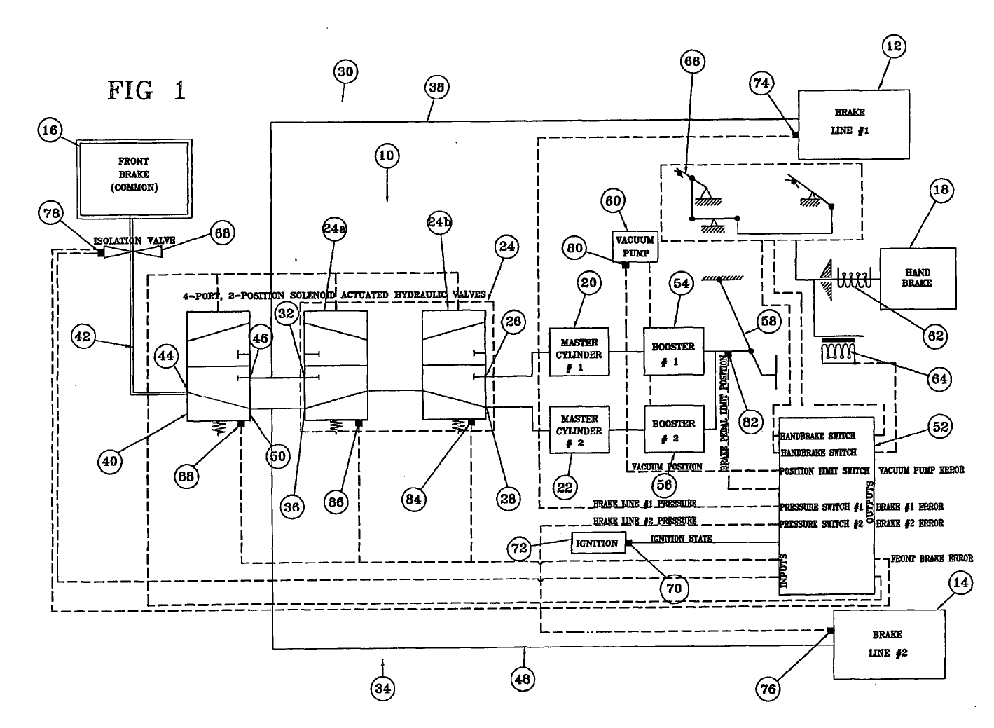

The controller 52 will conduct an automatic routine check of the sensors 70, 74, 76, 80 and 82 and, assuming that all characteristics sensed by the sensors are within prescribed levels or values, the pedal 58 when depressed pressurises both master cylinders 20 and 22 and controller 52 operates the valve 24 so as to couple only one of the hydraulic circuits 30 or 34 to one of the pressurised master cylinders 20 or 22. In FIG. 1, the master cylinder 22 is coupled via input port 28 and output port 36 of valve 24 to the hydraulic circuit 34. Accordingly service brake 14 is in fluid communication with the master cylinder 22 via the conduit 48 and valve 24, while the service brake 16 is in fluid communication with the master cylinder 22 via valve 24, valve 40 and common line 42.

When the brake pedal 58 is depressed, fluid pressure is communicated to the service brakes 14 and 16. Should sensor 76 detect a drop in fluid pressure at the service brake 14 the controller 52 can switch both valves 24 and 40 so that fluid pressure from the master cylinder 20 is directed to the output 32, and the input 46 of valve 40 becomes coupled to the output 44. Accordingly fluid pressure will now be provided to the service brakes 12 and 16. An indicator within a cabin of the vehicle in which the system 10 is installed may also be operated to inform the driver of a fault in the service brake 14 or the circuit 34 to which it is coupled.

Should the controller 52 detect that all of service brakes 12, 14 and 16 have failed, it automatically deploys the park brake 18 and turns OFF the ignition system 72.

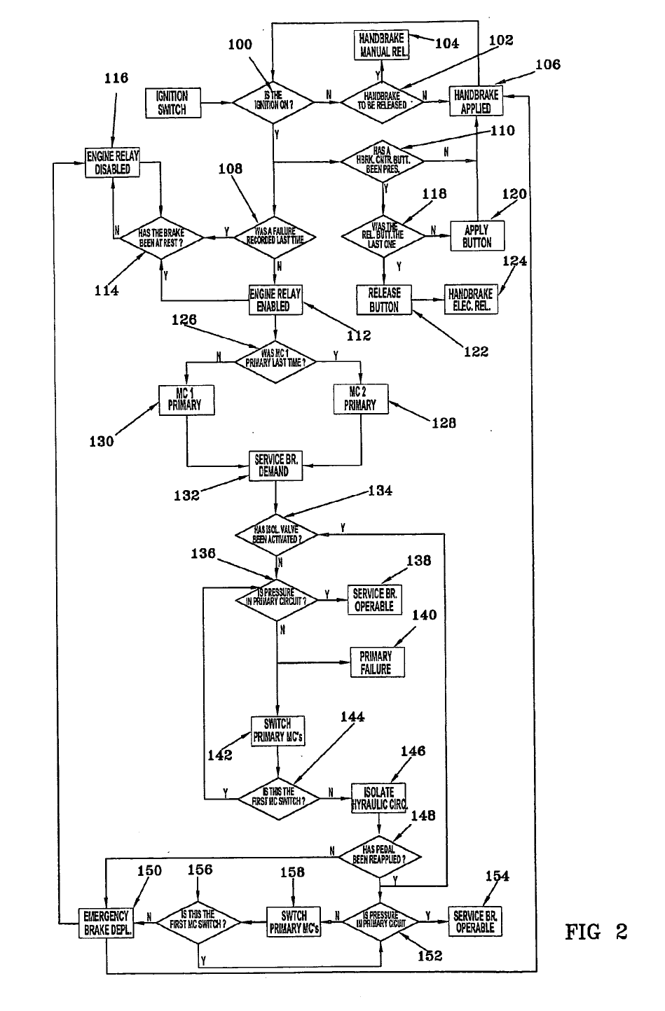

A more detailed description of the operational logic of the controller 52 and system 10 is depicted in FIG. 2.

At step 100, the controller 52 ascertains whether or not the ignition switch for a vehicle to which the system 10 is fitted is ON. As described above, if the ignition is in the OFF state, the park brake 18 is deployed. If at step 100 it is determined that the ignition switch is OFF and it is now desired to release the park brake at step 102, an operator must manually release the hand brake at step 104. If it is not desired to release the park brake then the park brake remains applied as indicated in state, 106.

If at step 100 it is determined that the ignition switch is ON then two further determinations are made at steps 108 and 110. At step 108 the controller determines whether or not a failure was recorded in the braking system the last time the ignition switch was in the ON state. If not, then an engine relay is enabled leading to state 112 enabling the vehicle to which the system 10 is applied to be driven.

If a failure was recorded at step 108, then, at step 114, a determination is made as to whether or not the failure has been rectified. If so, then the system again proceeds to state 112 where the engine relay is enabled allowing the vehicle to be driven. If not, then the engine relay is disabled leading to state 116 preventing the vehicle from being driven.

Concurrent with the processing at step 108, at step 110 the controller senses whether or not a park brake control button has been pressed. This may be a single button which is toggled to turn the park brake ON or OFF (i.e. apply or release the park brake) or alternately separate APPLY (i.e. ON) and RELEASE (i.e. OFF) buttons. In the event that the control button has not been pressed then the park brake remains in the applied state 106. In the event, at step 110, that the controller 52 determines the park brake control button has been pressed, the controller 52 then proceeds to step 118 where a determination is made as to whether or not the park brake RELEASE button has been pressed. If the answer to this determination is no, then by default it must have been the APPLY button that has been activated, indicated by state 120 applying the park brake at 106. On the other hand if the determination at step 118 is yes, then it is determined that the park brake RELEASE button has been pressed as indicated by state 122 thereby electrically releasing the park brake at step 124.

Assuming that the system has progressed to state 112 where the engine relay is enabled, the controller 52 at step 126 ascertains which of the master cylinders 20 or 22 was last used as the primary master cylinder in the hydraulic brake system 10. This is achieved at step 126 by ascertaining with reference to a log whether master cylinder 20 was the master cylinder last used to provide fluid pressure to the brake lines 30, 34. If the answer to this is yes, then the controller at step 128 operates the valve 24 in a manner so that master cylinder 22 becomes the cylinder providing fluid pressure to a selected one of hydraulic circuits 30, 34. On the other hand, if the answer at step 126 is no, then a controller at 130 operates the valve 24 so that the master cylinder 20 provides operational fluid pressure to one of the circuits 30 and 34.

After one of the master cylinders 20 or 22 have been designated the primary cylinder for the overall system 10, the controller waits at step 132 for an operator to use the service brakes. This will be detected by sensor 82 which senses for a depressing of the pedal 58. Thereafter, at step 134, the controller 52 ascertains whether or not isolation valve 68 has been activated. If not, the controller at step 136, commences a first routine polling various ones of sensors 74, 76, 84, 86 and 88, to determine whether or not fluid pressure exists in the selected primary circuit 30, or 34. If this is the case, then the service brake is in an operational state 138 and the service brake is applied in demand with depression of pedal 58. If not, then the system 10 enters a Primary Failure State 140 and simultaneously step 142 operates the valve 24 to enable the other master cylinder to provide fluid pressure to the overall hydraulic circuit 10. At step 144 a second routine is commenced where a determination is made as to whether or not the switch in master cylinders at step 142 is the first switch of master cylinders. If the answer to this question is yes, then the controller reverts to step 136, and now rechecks to see that there is fluid pressure in the selected hydraulic circuit.

If at step 144 it is determined that the switching of master cylinders at step 142 is not the first switch of master cylinders during the current ON state of the ignition switch, then at step 146 the controller 52 isolates the selected hydraulic circuit (ie 30 or 34 including common conduit 42) from the remainder of the system hydraulics and switches the other hydraulic circuit into communication with the current selected master cylinder. At this stage the controller assumes that a pressure leak exists in the previously selected hydraulic circuit since both master cylinders 20 and 22 have been switched to provide fluid pressure to the selected hydraulic circuits 30 or 34 with sensors still sensing insufficient fluid pressure. Should the controller proceed to step 146, this is indicative of an operator depressing the brake pedal 58 without the service brakes 12, 14 or 16 operating. Thereafter, the controller expects an operator to again depress the pedal 58 because the first depressing did not actuate the service brakes. If the pedal is not depressed within a predetermined time period, the controller 52 at step 150 enters an emergency mode where it automatically deploys the park brake 106 and disables the engine relay at step 116.

In the event at step 148 it is determined that the operator has depressed the pedal 58 within a predetermined time period, then a controller at step 152 polls the sensors 74, 76, 78, 84, 86 and 88 to determine whether or not the hydraulic circuit now designated as the primary circuit is sufficiently pressured to operate the service brakes 12 or 14 and 16. If this is the case, the service brakes are in an operable state 154. On the other hand, if at step 152 it is determined that there is not sufficient pressure in the hydraulic circuit, the controller at step 155 controls the valve 24 to switch the other master cylinder into fluid communication with the current selected hydraulic circuit. If at step 156 this is determined to be the second switching of master cylinders then the controller reverts to the emergency state 150 resulting in the engine relay being disabled (to run OFF the engine) and the park brake being deployed. This is indicative of both master cylinders 20 and 22 failing. In the event at step 156 that the switch of master cylinders is the first switch then the controller reverts to state 152 to determine whether or not there is sufficient pressure in the primary circuit to operate the service brakes and then proceeds to states 154 or 155 accordingly as described above.

If at step 134 it was determined that the isolation valve 68 has been activated then prima facie one of the hydraulic circuits 30 and 34 is faulty (ie has a leak). The isolation valve 68 and valve 24 will have isolated that hydraulic circuit from the remainder of the system hydraulics and switched the other hydraulic circuit (but not the common conduit 42) into fluid communication with the current selected (primary) master cylinder. The controller 52 then continues its operational cycle at step 152.

In embodiments of the present invention as would be obvious to a person of ordinary skill in the art are deemed to be within the scope of the present invention the nature of which is to be determined from the above description and the following claims.

The claims defining the invention are as follows:

1. A hydraulic brake system for a machine, said hydraulic brake system including:
at least one hydraulically actuated service brake;
at least one electrically deployable and manually releasable park brake;
first and second master cylinders;
a first valve having first and second input ports in fluid communication with said first and second master cylinders respectively;
a first hydraulic circuit in fluid communication with a first output port of said first valve, said first hydraulic circuit in fluid communication with said at least one service brake;
a second hydraulic circuit in fluid communication with a second output port of said first valve, said second hydraulic circuit in fluid communication with said at least one service brake;
a controller provided with one or more sensors for sensing operational characteristics of said hydraulic brake system including fluid pressure in said first and second hydraulic circuits, said controller operable for switching said first valve for selectively fluidly coupling said one of first or second master cylinders to said one of first or second hydraulic circuits and further operable for deploying said park brake upon detection of one or more triggering events

2. The system according to claim 1 wherein when said machine is a vehicle having an ignition system switchable between an ON state and an OFF state, a first one of said triggering events is detection of an OFF state of said ignition system.

3. The system according to claim 2 wherein said controller conducts a first routine to ascertain whether fluid pressure in a selected one of said first and second hydraulic circuits is below pre-determined level and, if so, operates said first valve to change the master cylinder fluidly coupled to said selected hydraulic circuit.

4. The system according to claim 3 wherein subsequent to first routine, said controller conducts a second routine to ascertain whether, said change in the master cylinder fluidly coupled to the selected hydraulic circuit, is the first change since a most recent switching of said ignition system to said ON state and if so said controller loops back to said first routine, and if not, said controller fluidly isolates said selected hydraulic circuit from said master cylinder fluidly previously coupled thereto and switches the other hydraulic circuit into fluid communication with said master cylinder.

5. The system according to claim 4 wherein subsequent to said second routine, said controller initiates a timer to ascertain whether a brake pedal operatively associated with said first and second master cylinders has been depressed within a time interval, and if not, classifies the failure to depress said brake circuit as a second one of said triggering events and consequently deploys said park brake.

6. The system according to claim 5 wherein if said controller determines that said brake pedal has been depressed within said time interval but subsequently ascertains that depression of said brake pedal does not result in fluid pressure in said selected hydraulic circuit exceeding a pre-determined level, said controller classifies the failure of the fluid pressure to exceed the pre-determined level as a third of said triggering events and consequently deploys said park brake.

7. The system according to claim 5 or 6 wherein said controller, upon detecting said second or third triggering events, switches said ignition system to said OFF state.

8. The system according to any one of claims 1-7 wherein said at least one hydraulically actuated service brake includes a first hydraulically actuated service brake and a second hydraulically actuated service brake, and each of first and second hydraulic circuits includes a second common valve having first and second input ports in fluid communication with said first and second output ports of said first valve respectively, and an output port in fluid communication through a common line to said second of said service brakes.
